(19) United States
(12) Patent Application Publication
(10) Pub. No.: US 2024/0177097 A1
(43) Pub. Date: May 30, 2024

(54) Automation tool and method

(71) Applicant: Rocket Software, Inc., Waltham, MA (US)

(72) Inventors: Raghav Sanjeev Nyapati, Hyderabad (IN); Ed Beauvais, Brookline, MA (US)

(21) Appl. No.: 18/205,024

(22) Filed: Jun. 2, 2023

Related U.S. Application Data
(60) Provisional application No. 63/348,655, filed on Jun. 3, 2022.

(51) Int. Cl. G06Q 10/0637; G06Q 10/0639; G06Q 10/10

(52) U.S. Cl. CPC G06Q 10/06375; G06Q 10/0639; G06Q 10/10

(57) ABSTRACT

Systems and methods for implementing an automated process. The systems include an interface for receiving at least one quantification metric associated with a first entity and at least one qualification metric associated with the first entity; and a processor executing instructions stored on memory to provide an automation decision for the first entity to implement an automated process based on the quantification metric associated with the first entity and the qualification metric associated with the first entity, wherein the interface is further configured to receive a validation metric associated with the implemented automated process.

### CROSS REFERENCE TO RELATED APPLICATIONS

The present application claims the benefit of and priority to co-pending U.S. provisional application No. 63/348,655, filed on Jun. 3, 2022, the content of which is hereby incorporated by reference as if set forth in its entirety herein.

### TECHNICAL FIELD

Embodiments described herein generally relate to systems and methods for automating procedures and, more particularly but not exclusively, to systems and methods for determining whether it is appropriate to automate procedures for measuring the efficacy of automated procedures.

### BACKGROUND

Entities such as corporations, government bodies, healthcare institutions, or the like are continuously challenged to adopt automation tools. In theory, automated tools improve productivity, reduce operational costs, increase capabilities, eliminate or reduce errors, reduce time-to-market, etc.

Oftentimes, however, administrators, stakeholders, or other interested parties are faced with multiple challenges to implement automated tools. These challenges may include deciding whether it is prudent to implement an automation tool, implementing the automation tool, and demonstrating the efficacy or effectiveness of the automation tool.

A need exists, therefore, for systems and methods that address these challenges associated with existing automation tools.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

According to one aspect, embodiments relate to a method for implementing an automated process. The method includes receiving at an interface at least one quantification metric associated with a first entity; receiving at the interface at least one qualification metric associated with the first entity; providing, using a processor executing instructions stored on memory, an automation decision for the first entity to implement an automated process based on the quantification metric associated with the first entity and the qualification metric associated with the first entity; and receiving a validation metric associated with the implemented automated process.

In some embodiments, the method further includes referencing a database storing data regarding a second entity including at least one quantification metric associated with the second entity, at least one qualification metric associated with the second entity, and whether the second entity implements an automated process, wherein the automation decision is further based on the data regarding the second entity. In some embodiments, the metrics associated with the first entity are in a first format and the metrics associated with the second entity are in a second format, and the method further includes transforming the metrics associated with the first entity into a standardized third format, transforming the metrics associated with the second entity into the standardized third format, updating the database with the transformed metrics, and transmitting a message to at least the first entity regarding the updated database so that the first entity has immediate access to up-to-date entity data.

In some embodiments, the interface is a RESTful application programming interface in operable communication with the first entity.

In some embodiments, the method further includes performing an anonymization procedure on the received at least one quantification metric and the at least one qualification metric.

In some embodiments, the at least one quantification metric associated with the entity includes a savings-based metric associated with gain in productivity resultant from the automated process, manual work time saved resultant from the automated process, savings obtained from error reduction resultant from the automated process, or entity employee cost savings resultant from the automated process.

In some embodiments, the at least one quantification metric associated with the first entity includes a cost-based metric.

In some embodiments, the automation decision includes at least one bot to implement the automated process. In some embodiments, the method further includes generating a performance report of the bots indicating a performance level of each of the bots

In some embodiments, the method further includes modifying the automated process based on the received validation metric.

According to another aspect, embodiments relate to a system for implementing an automated process. The system includes an interface for receiving at least one quantification metric associated with a first entity and at least one qualification metric associated with the first entity; and a processor executing instructions stored on memory to provide an automation decision for the first entity to implement an automated process based on the quantification metric associated with the first entity and the qualification metric associated with the first entity, wherein the interface is further configured to receive a validation metric associated with the implemented automated process.

In some embodiments, the system further includes a database storing data regarding a second entity including at least one quantification metric associated with the second entity, at least one qualification metric associated with the second entity, and whether the second entity implements an automated process, wherein the automation decision is further based on the data regarding the second entity. In some embodiments, the metrics associated with the first entity are in a first format and the metrics associated with the second entity are in a second format, and the processor is further configured to transform the metrics associated with the first entity into a standardized third format, transform the metrics associated with the second entity into the standardized third format, update the database with the transformed metrics, and transmit a message to at least the first entity regarding the updated database so that the first entity has immediate access to up-to-date entity data.

In some embodiments, the interface is a RESTful application programming interface in operable communication with the first entity.

In some embodiments, the processor is further configured to perform an anonymization procedure on the received at least one quantification metric and the at least one qualification metric.

In some embodiments, the at least one quantification metric associated with the entity includes a savings-based metric associated with gain in productivity resultant from the automated process, manual work time saved resultant from the automated process, savings obtained from error reduction resultant from the automated process, or entity employee cost savings resultant from the automated process.

In some embodiments, the at least one quantification metric associated with the entity includes a cost-based metric.

In some embodiments, the automation decision includes at least one bot to implement the automated process. In some embodiments, the processor is further configured to generate a performance report of the bots indicating a performance level of each of the bots.

In some embodiments, the processor is further configured to modify the automated process based on the received validation metric.

### BRIEF DESCRIPTION OF DRAWINGS

Non-limiting and non-exhaustive embodiments of the invention are described with reference to the following figures, wherein like reference numerals refer to like parts throughout the various views unless otherwise specified.

FIG. 1 illustrates a system for implementing an automated process in accordance with one embodiment;

FIG. 2 presents an exemplary industry-specific questionnaire in accordance with one embodiment;

FIG. 3 presents an exemplary generic questionnaire in accordance with one embodiment;

FIG. 4 presents a user interface for enabling a user to input metrics related to operational costs in accordance with one embodiment;

FIG. 5 presents a user interface for enabling a user to input metrics related to technology or licensing costs in accordance with one embodiment;

FIG. 6 presents a user interface for enabling a user to input metrics related to savings in accordance with one embodiment;

FIG. 7 presents a user interface for presenting various ROI values in accordance with one embodiment;

FIGS. 8A-D present user interfaces for presenting validation metrics in accordance with various embodiments;

FIG. 9 depicts a flowchart of a workflow for implementing an automated process in accordance with one embodiment; and

FIG. 10 depicts a flowchart of a method for implementing an automated process in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

Entity administrators, managers, stakeholders, or other interested parties (for simplicity, “administrator(s)”) must consider several factors in deciding whether to automate a procedure. For example, they may first need to find candidate processes for automation. That is, just because a process could be automated, it does not necessarily mean the benefit gained would justify the time and cost in implementing the automated process.

Implementing an automation tool may also require significant upfront costs. Accordingly, administrators must decide how to quantify or otherwise demonstrate the economic value of automation to their superiors, owners, stakeholders, or the like.

Even after adoption of an automated process, administrators must decide how to collect usage metrics and data to determine their return on investment (ROI) and total cost of ownership (TCO). These metrics may at least help validate their decision to shift to automation.

The embodiments described herein provide a set of methodologies and toolkits to allow users to provide details for determining whether a particular candidate process should be automated. The embodiments described herein also allow users to input data for quantification. Metrics associated with quantification may include ROI and TOC, for example. Users can also calibrate metrics for validation in a unified fashion using a single tool.

Additionally or alternatively, metrics associated with an entity may be continuously provided in at least substantially real time. Data regarding automated processes may be transformed into any suitable format such that it can be analyzed by the one or more processors to provide an automated decision (i.e., whether a procedure should be automated).

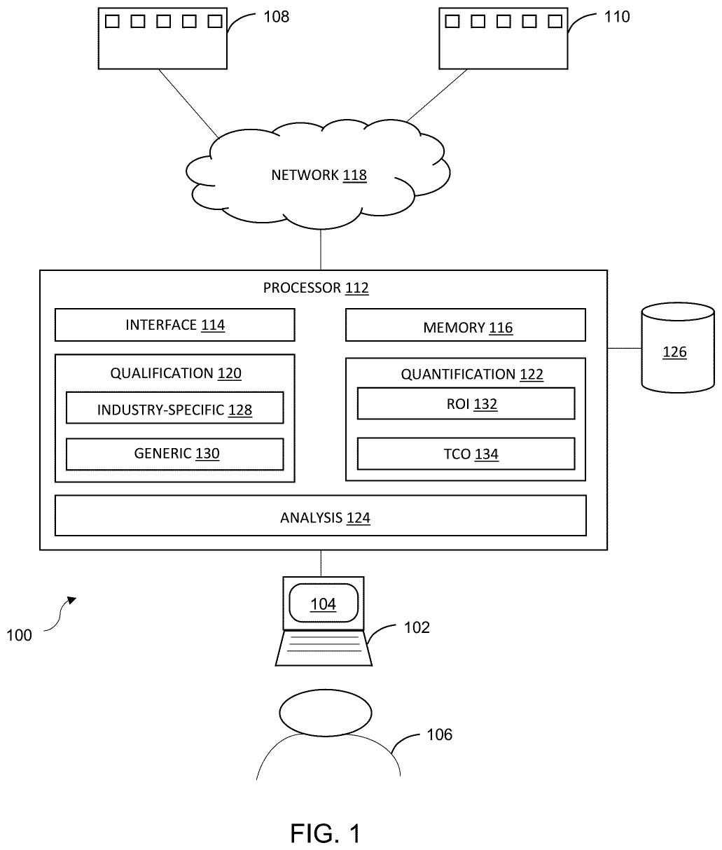

FIG. 1 illustrates a system for implementing an automated process in accordance with one embodiment. The system 100 may include a user device 102 executing a user interface 104 accessible by one or more users 106.

The user device 102 may be any suitable device capable of presenting the user interface 104 to the user 106. The user device 102 may be a smartphone, tablet, PC, laptop, smart TV, smartwatch, or any other type of device whether available now or invented hereafter.

The user 106 may include an administrator tasked with determining whether it is appropriate to automate a process. The user 106 may be associated with one of the entities 108, 110, for example, and may provide various parameters regarding manually-performed processes. In these embodiments, the user 106 may first want to know whether it is appropriate to automate any of the manually-performed processes.

The user 106 may similarly be interested in viewing performance metrics associated with an automated process. For example, the user 106 may be an administrator or stakeholder interested in knowing the efficacy of an automated process, how well that automated process performs, the cost(s) associated with implementing the automated process(es), the savings resultant from implementing the automated process(es), or the like.

The user interface 104 may also provide updates to the user 106. For example, in some circumstances it may not be appropriate to automate a procedure. However, circumstances may change such that it may eventually be appropriate to automate a procedure (e.g., the number of employees performing manual process increases to some prohibitive level). Accordingly, the user interface 104 may alert the user 106 to the change in circumstances.

The user device 102 may be in communication with one or more processors 112 including an interface executing instructions on memory 116. The processor(s) 112 may be any hardware device capable of executing instructions stored on memory 116 to provide various components or modules, discussed below. The processor 112 may include a microprocessor, a field programmable gate array (FPGA), an application-specific integrated circuit (ASIC), or other similar devices.

In some embodiments, such as those relying on one or more ASICs, the functionality described as being provided in part via software may instead be configured into the design of the ASICs and, as such, the associated software may be omitted. The processor 112 may be configured as part of the user device 102 (e.g., a laptop) or located at some remote location.

The memory 116 may be L1, L2, L3 cache, or RAM memory configurations. The memory 116 may include non-volatile memory such as flash memory, EPROM, EEPROM, ROM, and PROM, or volatile memory such as static or dynamic RAM, as discussed above. The exact configuration/type of memory 116 may of course vary as long as instructions for performing the various steps described herein can be performed by the system 100

The processor(s) 112 may be in operable connectivity with one or more entities 108 and 110 over one or more networks 118. The network(s) 118 may link the various components with various types of network connections. The network(s) 118 may be comprised of, or may interface to, any one or more of the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1, or E3 line, a Digital Data Service (DDS) connection, a Digital Subscriber Line (DSL) connection, an Ethernet connection, an Integrated Services Digital Network (ISDN) line, a dial-up port such as a V.90, a V.34, or a V.34bis analog modem connection, a cable modem, an Asynchronous Transfer Mode (ATM) connection, a Fiber Distributed Data Interface (FDDI) connection, a Copper Distributed Data Interface (CDDI) connection, or an optical/DWDM network.

The network or networks 118 may also comprise, include, or interface to any one or more of a Wireless Application Protocol (WAP) link, a Wi-Fi link, a microwave link, a General Packet Radio Service (GPRS) link, a Global System for Mobile Communication (GSM) link, a Code Division Multiple Access (CDMA) link, or a Time Division Multiple access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based link.

The one or more entities 108, 110 may communicate one or more parameters associated with their implemented processes. For example, the entities 108, 110 may be healthcare institutions and may routinely process insurance claims. In other embodiments, the entities 108, 110 may be financial institutions and may routinely process loan applications. The embodiments described herein are not limited to any particular type of entity, environment, or business, however. Similarly, the embodiments described herein are not limited to any particular type of process.

The processor(s) 112 may include or otherwise execute various modules such as a qualification module 120, a quantification module 122, and an analysis engine 124. The processor(s) 112 may also be in communication with one or more databases 126.

The qualification module 120 may execute one or more sub-modules to perform a qualification analysis. These may include, but are not limited to, an industry-specific submodule 128 and a generic submodule 130. The qualification module 120 may consider or otherwise analyze one or more metrics from an entity that relate to the entity's operation.

The qualification module 120 may receive metrics such as the entity's type of industry, size of the entity (e.g., in terms of employees, revenue, profit, market capitalization, etc.), business case details, overview of implemented processes, names of process owners, or the like. As part of the qualification step(s), a user 106 may also provide qualification metrics such as, but not limited to, process metrics, user metrics, application metrics, and quality metrics.

The user 106 may be presented with an interface to provide this qualification data. For example, the embodiments herein allow a user to select an “industry-specific” option or a “generic” option. If the user selects via the interface 104 an industry-specific option, the industry-specific submodule 128 may present an interface specific to the user's or entity's industry.

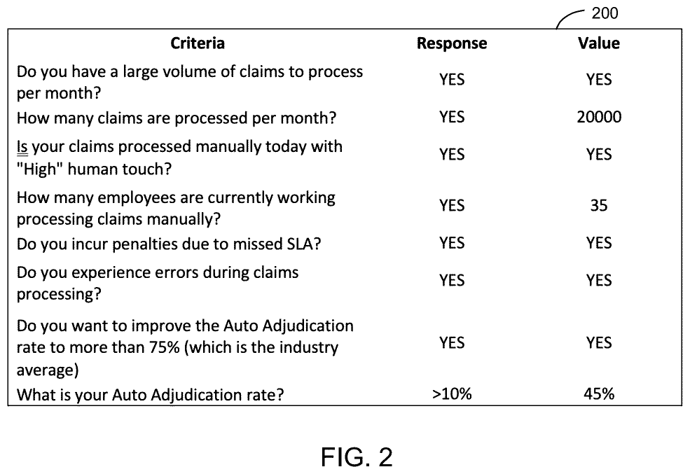

FIG. 2 presents an exemplary industry-specific questionnaire 200 in accordance with one embodiment. In this instance, the entity may be a healthcare institution, and the questionnaire 200 may include questions regarding the processing of claims. As seen in FIG. 2, the industry-specific submodule 128 may ask for and allow a user to input data such as how many claims are processed per month, how many employees are processing claims, whether there are errors, how many errors, etc.

If the user 106 selects via the interface 104 a generic option, the generic submodule 130 may present a generic questionnaire that is not specific to a particular industry or type of entity. However, the generic questionnaire may still allow the user 106 to input metrics regarding their operations.

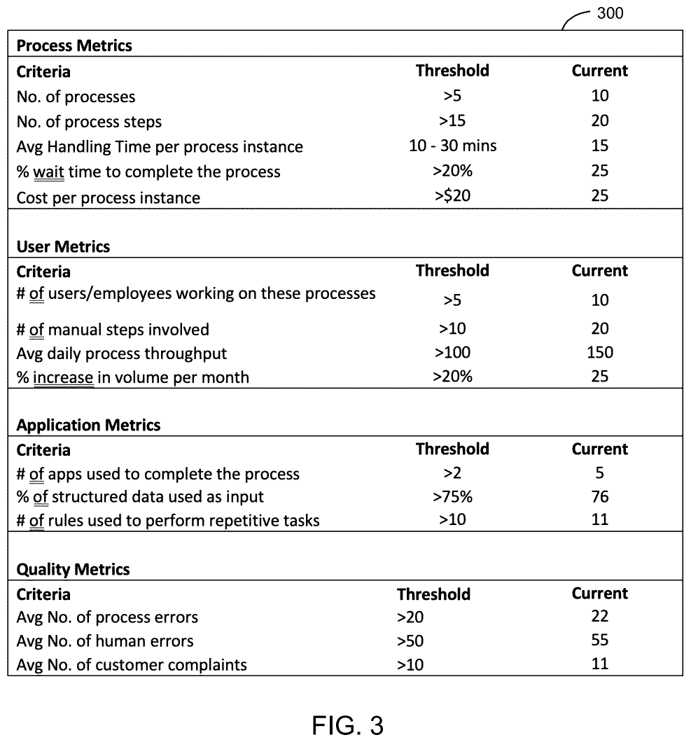

FIG. 3 presents an exemplary generic questionnaire 300 in accordance with one embodiment. In this instance, the presented questions are not specific to any particular industry or type of entity. As seen in FIG. 3, the qualification tool 120 may ask for and allow a user to input data such as the number of processes, the number of employees working on these processes, the number of applications used to complete the process(es), and the number of errors associated with these processes. These types of data may be sorted into various groups such as process metrics, user metrics, application metrics, and quality metrics.

Referring back to FIG. 1, the processor(s) 112 may also execute a quantification module 122. The quantification module 122 may consider metrics to determine, quantify, or otherwise demonstrate the economic value of automation. The quantification module 122 may execute various submodules such as, but not limited to, a return-on-investment (ROI) submodule 132 and a total-cost-of-ownership (TCO) submodule 134.

The ROI submodule 132 may determine the possible or actual return on investment of automating one or more processes. The ROI submodule 132 may analyze various aspects associated with cost. For example, the ROI submodule 132 may consider operational costs, technology or licensing costs, service costs, or some combination thereof.

Operational costs may refer to costs associated with running a business. In the healthcare industry, for example, these costs may be those incurred due to manual processing of claims, costs due to fraud detection by users, costs of remedying fraud, costs to remedy errors, or the like.

FIG. 4 presents a user interface 400 for enabling a user to input metrics related to operational cost in accordance with one embodiment. For example, the user may input metrics based on expected numbers of claims and manual costs associated therewith.

The technology or licensing costs may refer to costs incurred by the entity in purchasing automation software or associated licenses. That is, these may refer to the costs of software that will be or is used to automate a process. Technology or licensing costs may be a one-time, upfront cost, or may be a recurring cost. These costs may also vary depending on the size of the entity (e.g., how many employees will be using the automated software).

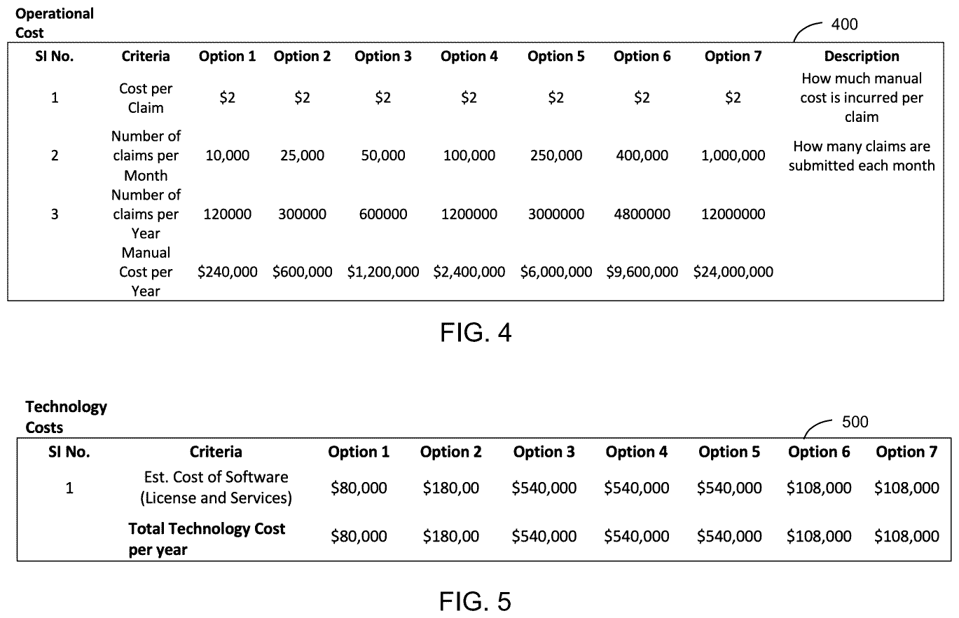

FIG. 5 presents a user interface 500 for enabling a user to input metrics related to technology or licensing costs. A user may need to enter data only into one field of the “Est. Cost of Software” field.

Service costs may refer to or include costs the entity incurs for implementing an automation solution in their organization. For example, these costs may include those associated with hiring or paying software experts to integrate the automation solution in their organization, or costs associated with ensuring the automated solution complies with any applicable regulations.

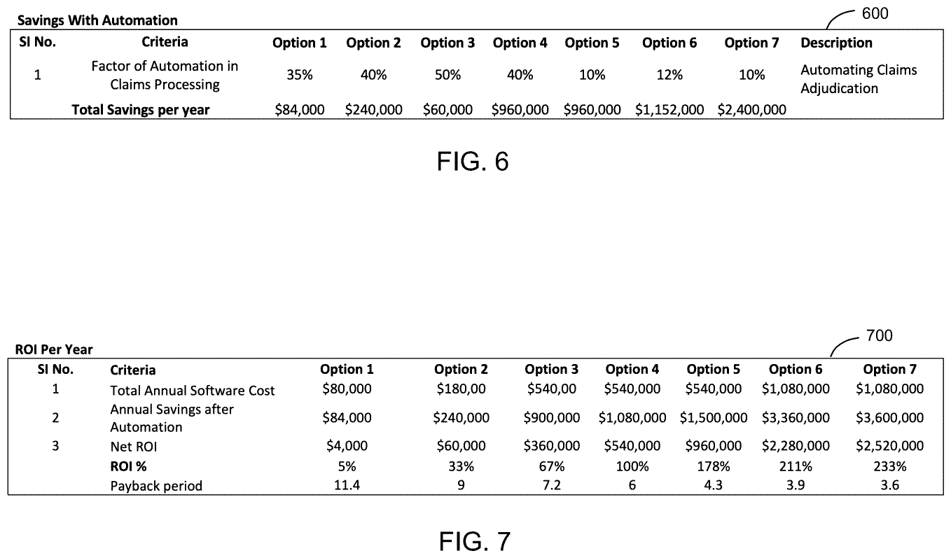

FIG. 6 presents a user interface 600 for enabling a user to input metrics related to savings. For example, in this embodiment, a user may enter possible amounts in terms of percentages of how many processes are to be automated.

The inputs associated with FIGS. 4-6 are each associated with healthcare. In some instances, the interfaces of FIGS. 4-6 may be grouped together such that a user provides the required inputs at approximately the same time.

FIG. 7 presents a user interface 700 for presenting various ROI values in accordance with one embodiment. The presented ROI values may be based on the values entered in FIGS. 4-6. As seen in FIG. 7, the user interface 700 presents various values for different options. For example, the values associated with the Option 1 column of user interface 700 may be based on the values of the Option 1 columns of FIGS. 4-6. As seen in FIG. 7, the embodiments herein may determine and provide ROI in terms of returns per year or payback period to obtain the initial investment.

Referring back to FIG. 1, the processor(s) 112 may also execute an analysis module 124. The analysis module 124 may continuously collect or otherwise receive data from implemented customer automation instances. This information may be received in substantially real time, or may be communicated to the analysis module at predetermined intervals (e.g., hourly, daily, weekly, etc.).

The analysis module 124 may provide data or outputs validating a decision to automate a process, or data or outputs critiquing the decision to automate a process. For example, the analysis module 124 may assess how well the automation processes are working, such as in terms of whether the automated processes are improving the entity's workflows and by how much. Accordingly, the analysis module 124 may provide some objective assessment the entity can use to see or demonstrate the efficacy of their automated processes.

Automated metrics analyzed may include, but are not limited to, number of processes automated, number of automation executions, number of steps or screens navigated by the automated process, number of hours saved from automation, number of employees rendered superfluous to perform manual steps, number of errors reduced due to the automation, percentage of automation achieved through the tool, or some combination thereof.

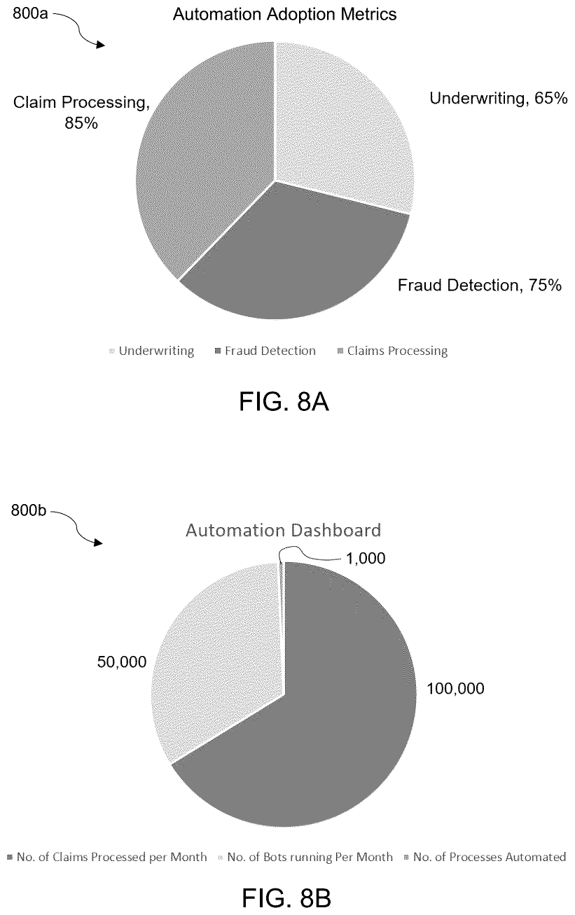

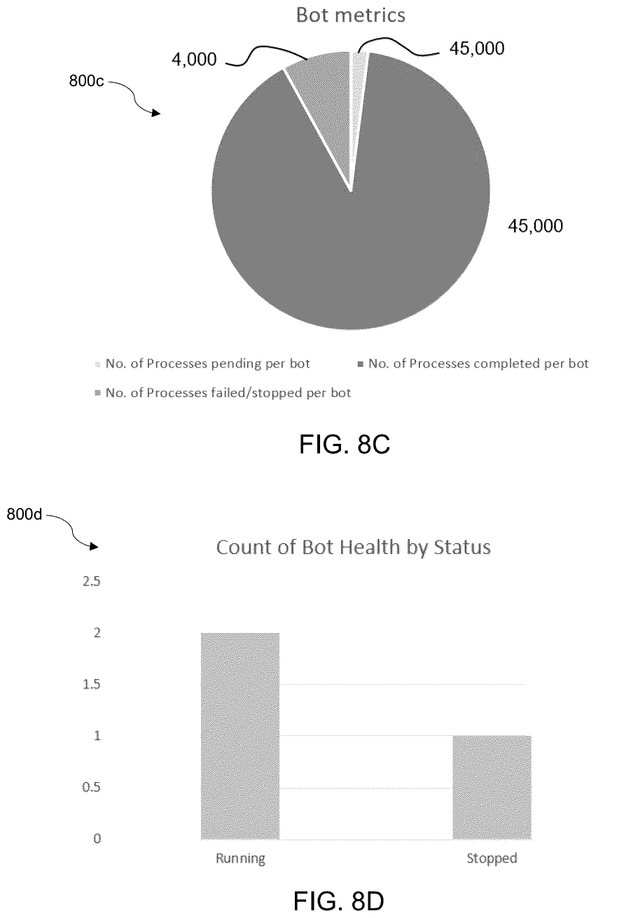

The analysis module 124 may output any one or more of a variety of metrics. Additionally, the analysis module 124 may cause the user interface 102 to present the metrics in a variety of ways. FIGS. 8A-D depict user interfaces presenting automation metrics in accordance with various embodiments.

FIG. 8A presents a user interface 800a showing automation adoption metrics in accordance with one embodiment. In this case, the user interface 800a shows that 85% of claims processing procedures have been automated, 75% of fraud detection procedures have been automated, and 65% of underwriting procedures have been automated.

FIG. 8B presents a user interface 800b showing automation metrics in accordance with one embodiment. In this case, the user interface 800b shows that there are 100,000 processed claims per month, 1,000 automated bots running per month, and 50,000 processes automated per month.

FIG. 8C presents a user interface 800c showing bot metrics in accordance with one embodiment. The associated bots may be tasked with automating one or more processes. In this case, the user interface 800c shows that there are 1,000 processes running per bot, 45,000 processes completed per bot, and 4,000 processes that have failed or stopped per bot.

FIG. 8D presents a user interface 800d showing bot health statistics in accordance with one embodiment. In this case, there may be two bots running as intended, and one bot that has stopped.

Accordingly, the embodiments described herein may present a variety of metrics in an easy-to-understand manner. The metrics shown in FIGS. 8A-D are exemplary and other types of metrics in addition to or in lieu of those described above may be presented.

For example, the embodiments herein may present metrics associated with direct and indirect savings due to automation. These metrics may relate to time savings, quality improvement (as determined based on number of errors and the percentage of errors reduced), productivity gain, and competitive advantage as determined by the reduction in customer complaints, etc.

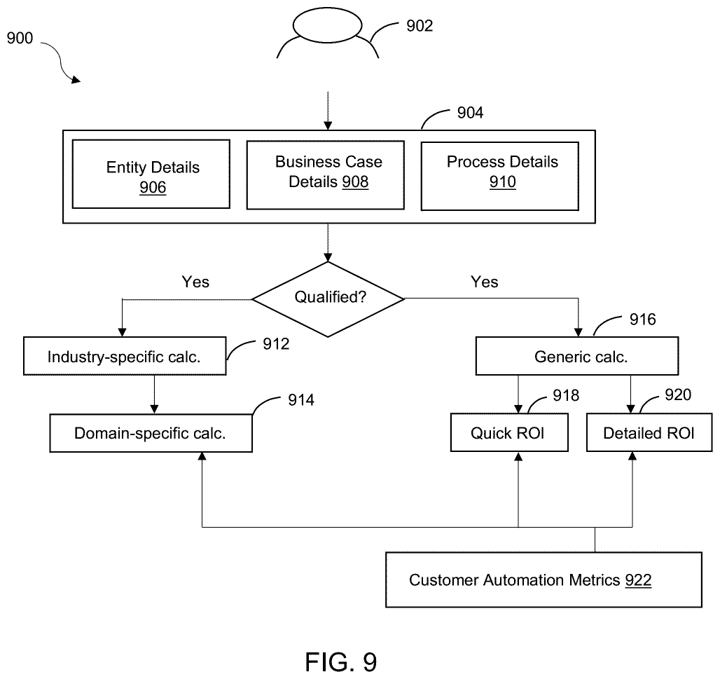

FIG. 9 depicts a flowchart of a workflow 900 for implementing an automated process in accordance with one embodiment. The workflow 900 may involve one or more of the components of FIG. 1, for example. The workflow 900 may involve a qualification stage, a quantification stage, and a validation phase.

In operation a user 902 may input details regarding their business. The user 902 may provide these details to a processor 904 such as the processor(s) 112 of FIG. 1. These inputted details may include entity details 906, business case details 908, process details 910, or some combination thereof.

The processor 904 may then perform a qualification analysis to determine whether a process qualifies for automation. The workflow 900 may involve an industry-specific automation calculator 912 and, more specifically, a domain-specific automation calculator 914. For example, the embodiments herein may gather or consider data that is specific to a particular entity's industry or a domain within said industry.

Alternatively, the workflow may involve a generic calculator 916. The generic calculator 916 may perform a “quick” ROI analysis 918 or a detailed ROI analysis 920. The quick ROI analysis 918 allows a user to calculate whether a process is appropriate based on a limited set of inputted data. The detailed ROI analysis 920 may involve analyzing more data than what is considered in the quick ROI analysis 918, such as the costs and savings metrics discussed previously. These savings may relate to savings due to error reduction, benefits due to productivity gains, the ability to address customer complaints more quickly, or the like.

The validation phase of FIG. 9 involves capturing customer automation metrics 922 from customer implementation(s) of the automation procedures. As discussed above, these metrics may include, but are not limited to, the number of bots running in the customer's environment, the number of processes that are automated, the number of screens that are navigated through bots, the percentage of automation achieved, or some combination thereof. The above list is merely exemplary and other metrics in addition to or in lieu of those mentioned above may be considered and may depend on the application. These metrics may be used to validate the use of automated processes, identify areas for improvement, and provide feedback regarding the use of automated processes.

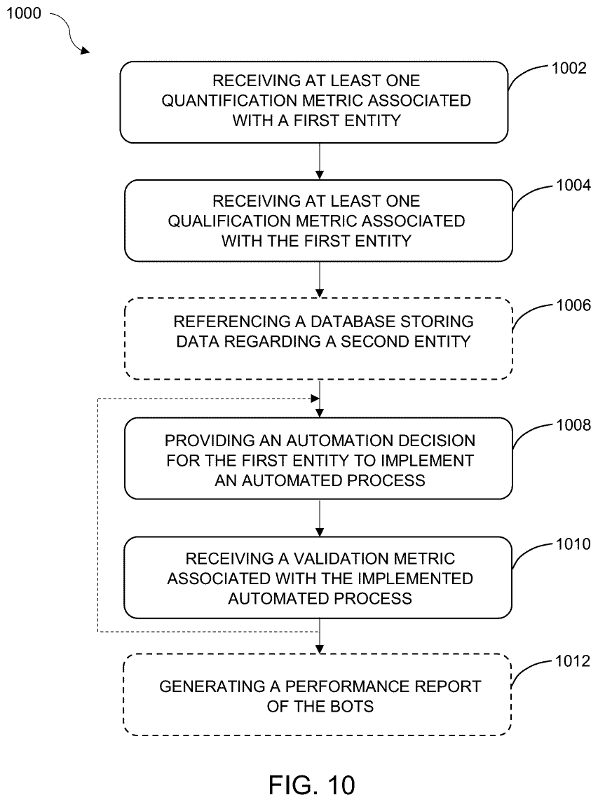

FIG. 10 depicts a flowchart of a method 1000 for implementing an automated process in accordance with one embodiment. The system 100 of FIG. 1 or components thereof may perform one or more of the steps of method 1000.

Step 1002 involves receiving at an interface at least one quantification metric associated with a first entity. The interface may be similar to the interface 114 of FIG. 1, for example. In some embodiments, the interface may be a RESTful application programming interface in operable communication with the first entity. The quantification metric associated with the entity may include a savings-based metric associated with gain in productivity resultant from the automated process, manual work time saved resultant from the automated process, savings obtained from error reduction resultant from the automated process, entity employee cost savings resultant from the automated process, or some combination thereof.

Step 1004 involves receiving at the interface at least one qualification metric associated with the first entity. The qualification metric may relate to details of the entity's business or process details, for example.

Step 1006 involves referencing a database storing data regarding a second entity. The data regarding the second entity may include at least one quantification metric associated with the second entity, at least one qualification metric associated with the second entity, and whether the second entity implements an automated process.

Accordingly, the embodiments herein may also leverage data regarding how well a second entity has implemented an automated process. The embodiments described herein may also take into account characteristics of the second entity, such as the number of employees, market capitalization of the second entity, etc. If these characteristics are similar to the characteristics of the first entity, and the second entity has successfully automated a process, it may make sense for the first entity to automate a similar process as well.

Step 1008 involves providing, using the processor executing instructions stored on memory, an automation decision for the first entity to implement an automated process based on the quantification metric associated with the first entity and the qualification metric associated with the first entity. The automation decision may also be based on the data regarding the second entity referenced in step 1006 above.

Step 1010 involves receiving a validation metric associated with the implemented automated process. The validation metric may relate to savings resulting from automation, reduction of errors resulting from automation, time saved from process automation, or some combination thereof.

Step 1012 involves generating a performance report of the bots. A performance report may present metrics in an easy-to-understand format, such as in FIGS. 8A-D. Accordingly, a user or other interested party can view the efficacy of automated processes.

The steps of method 1000 may be iterated. For example, and as seen in FIG. 10, the automation decision may be updated based on a received validation metric. That is, if a validation metric indicates that an implemented automated process is not effective, the automation decision may be updated such that the process is subsequently performed manually.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A method for implementing an automated process, the method comprising:
receiving at an interface at least one quantification metric associated with a first entity;
receiving at the interface at least one qualification metric associated with the first entity;
providing, using a processor executing instructions stored on memory, an automation decision for the first entity to implement an automated process based on the quantification metric associated with the first entity and the qualification metric associated with the first entity; and
receiving a validation metric associated with the implemented automated process.

2. The method of claim 1 further comprising referencing a database storing data regarding a second entity including:
at least one quantification metric associated with the second entity,
at least one qualification metric associated with the second entity, and
whether the second entity implements an automated process,
wherein the automation decision is further based on the data regarding the second entity.

3. The method of claim 2 wherein the metrics associated with the first entity are in a first format and the metrics associated with the second entity are in a second format, and the method further includes:
transforming the metrics associated with the first entity into a standardized third format,
transforming the metrics associated with the second entity into the standardized third format,
updating the database with the transformed metrics, and
transmitting a message to at least the first entity regarding the updated database so that the first entity has immediate access to up-to-date entity data.

4. The method of claim 1 wherein the interface is a RESTful application programming interface in operable communication with the first entity.

5. The method of claim 1 further comprising performing an anonymization procedure on the received at least one quantification metric and the at least one qualification metric.

6. The method of claim 1 wherein the at least one quantification metric associated with the entity includes a savings-based metric associated with gain in productivity resultant from the automated process, manual work time saved resultant from the automated process, savings obtained from error reduction resultant from the automated process, or entity employee cost savings resultant from the automated process.

7. The method of claim 1 wherein the at least one quantification metric associated with the first entity includes a cost-based metric.

8. The method of claim 1 wherein the automation decision includes at least one bot to implement the automated process.

9. The method of claim 8 further comprising generating a performance report of the bots indicating a performance level of each of the bots.

10. The method of claim 1 further comprising modifying the automated process based on the received validation metric.

11. A system for implementing an automated process, the system comprising:
an interface for receiving:
at least one quantification metric associated with a first entity;
at least one qualification metric associated with the first entity; and
a processor executing instructions stored on memory to provide an automation decision for the first entity to implement an automated process based on the quantification metric associated with the first entity and the qualification metric associated with the first entity, wherein the interface is further configured to receive a validation metric associated with the implemented automated process.

12. The system of claim 11 further comprising a database storing data regarding a second entity including at least one quantification metric associated with the second entity, at least one qualification metric associated with the second entity, and whether the second entity implements an automated process, wherein the automation decision is further based on the data regarding the second entity.

13. The system of claim 12 wherein the metrics associated with the first entity are in a first format and the metrics associated with the second entity are in a second format, and the processor is further configured to:
transform the metrics associated with the first entity into a standardized third format,
transform the metrics associated with the second entity into the standardized third format,
update the database with the transformed metrics, and
transmit a message to at least the first entity regarding the updated database so that the first entity has immediate access to up-to-date entity data.

14. The system of claim 11 wherein the interface is a RESTful application programming interface in operable communication with the first entity.

15. The system of claim 11 wherein the processor is further configured to perform an anonymization procedure on the received at least one quantification metric and the at least one qualification metric.

16. The system of claim 11 wherein the at least one quantification metric associated with the entity includes a savings-based metric associated with gain in productivity resultant from the automated process, manual work time saved resultant from the automated process, savings obtained from error reduction resultant from the automated process, or entity employee cost savings resultant from the automated process.

17. The system of claim 11 wherein the at least one quantification metric associated with the entity includes a cost-based metric.

18. The system of claim 11 wherein the automation decision includes at least one bot to implement the automated process.

19. The system of claim 18 wherein the processor is further configured to generate a performance report of the bots indicating a performance level of each of the bots.

20. The system of claim 11 wherein the processor is further configured to modify the automated process based on the received validation metric.
